(19) United States
(12) Patent Application Publication
(10) Pub. No.: US 2017/0053043 A1
(43) Pub. Date: Feb. 23, 2017

(54) SYSTEMS AND METHODS FOR LOCATING STRUCTURES FOR ROOFTOP SOLAR PANEL INSTALLATION

(71) Applicant: SolarCity Corporation, San Mateo, CA (US)

(72) Inventors: Jesse LaRue, Oakland, CA (US); Travis Brier, San Mateo, CA (US)

(21) Appl. No.: 14/832,831

(22) Filed: Aug. 21, 2015

(51) Int. Cl. G06F 17/50; H02S 20/23

(52) U.S. Cl. CPC G06F 17/5004; H02S 20/23

(57) ABSTRACT

Embodiments of the present technology may include a computer-implemented method to indicate a solar panel mounting location. The method may include receiving, by a processor, a first data set including three-dimensional data for a top side of a roof of a solar panel installation site. The method may also include receiving, by a processor, a second data set including three-dimensional data for a bottom side of the roof The method may further include identifying a rafter in the second data set based on a predetermined profile. Additionally, the method may include determining a relative location of the rafter with respect to the bottom side of the roof. In embodiments, the method may also include generating an output indicating a solar panel mounting location on the top side of the roof based on the location of the rafter.

### TECHNICAL FIELD

Embodiments of the present technology are related to the installation of solar photovoltaic panels or other hardware on building roofs and similar structures.

### BACKGROUND

Concern about climate change, pollution, energy security, and/or energy independence have led to regulations and incentives for diversifying energy sources and increasing renewable energy production in the United States and other countries. One type of renewable energy source is solar photovoltaic technology, which includes the direct conversion of sunlight to electricity. For solar photovoltaic cell technology, costs have decreased and efficiency has increased. As a result of regulation, incentives, costs, and greater market acceptance, solar photovoltaic installations have increased in recent years, including installations on commercial, industrial, and residential rooftops. Although the costs of the solar photovoltaic cells have decreased, the cost of the framing and the installation have not decreased by the same magnitude. These so-called balance of system (BOS) costs remain a significant portion of the total cost of electricity produced from solar photovoltaic technology. Decreasing the installation costs, and therefore, the BOS costs, along with other issues may be addressed by embodiments described herein.

### BRIEF SUMMARY

Solar installations on rooftops often include the fastening of a mounting frame onto a roof. Specifically, the mounting frame may be nailed through roof decking to a rafter, other beam of a roof, or other appropriate supporting structure of the roof. Accurately determining the location of the rafter or similar structure under the roof decking may increase the efficiency of installing solar panels on buildings. If an installer on the top of a roof knows where a rafter is, the installer may be able to create a hole in the roof for a fastener in only one attempt. Embodiments of the present technology may eliminate unnecessary holes in the roof, which may be the result of inaccurate and/or imprecise estimates of the location of a rafter. Unnecessary holes may weaken the integrity of the roof, make the roof more susceptible to leaks, and/or reduce consumer acceptance of solar panels. Additionally, even without the added time associated with creating and fixing unnecessary holes, embodiments of the present technology may reduce installation time by decreasing time for measurements and eliminating repeated measurements during install. In many instances, embodiments of the present technology may be able to identify locations for fasteners of solar panel frames to within one centimeter or better.

Embodiments of the present technology may include a method to indicate a solar panel mounting location. The method may include receiving, by a processor, a first data set including three-dimensional data for a top side of a roof of a solar panel installation site. The method may also include receiving, by a processor, a second data set including three-dimensional data for a bottom side of the roof The method may further include identifying a rafter in the second data set based on a profile. The profile may have a predetermined set of dimensions and a predetermined location with respect to the bottom side of the roof Additionally, the method may include determining a relative location of the rafter with respect to the top side of the roof. In embodiments, the method may also include generating an output indicating a solar panel mounting location on the top side of the roof based on the location of the rafter.

Some embodiments may include a method to determine the deflection of a roof The method may include receiving, by a processor, a data set including three-dimensional data for a bottom side of a roof of a solar panel installation site. The method may also include identifying four points in the three-dimensional data. Each point in the three-dimensional data may be the center of a region of a plurality of points. The region may have a predetermined size. Within each region, the difference in depth between any two points of the plurality of points may be less than a predetermined depth. The method may further include determining a displacement of one of the four points from a plane formed by the other three points. In addition, the method may include determining a deflection of the roof using the displacement.

Embodiments of the present technology may include a computer system. The computer system may include a non-transitory computer readable medium storing a plurality of instructions that when executed control a computer system to generate an output indicating a solar panel mounting location on the top side of a roof of a solar panel installation site. The instructions may include receiving a first data set including three-dimensional data for a top side of a roof of a solar panel installation site. The instructions may also include receiving a second data set including three-dimensional data for a bottom side of the roof. Additionally, the instructions may include identifying a rafter in the second data set based on a profile. The profile may include a predetermined set of dimensions and a predetermined location with respect to the top side of the roof Furthermore, the instructions may include determining a relative location of the rafter with respect to the top side of the roof using the first data set, the predetermined set of dimensions, and the predetermined location.

Embodiments of the present technology may include a method to generate an output indicating a solar panel mounting location. The method may include receiving, by a processor, a first data set including three-dimensional data for a top side of a roof of the solar panel installation site. The method may also include, receiving, by a processor, a second data set including three-dimensional data for a bottom side of the roof The method may further include identifying a structure in the second data set based on a profile. The profile may have a predetermined set of dimensions and a predetermined location with respect to the bottom side of the roof In addition, the method may include determining a relative location of the structure with respect to the top side of the roof using the first data set, the predetermined set of dimensions, and the predetermined location. The method may also include generating an output indicating a solar panel mounting location on the top side of the roof based on the location of the structure.

### BRIEF DESCRIPTION OF THE DRAWINGS

FIG. 1 shows a top view of a roof and components of a roof according to embodiments of the present technology.

FIG. 2 shows a bottom view of components of a roof according to embodiments of the present technology.

FIG. 3 shows a block flow diagram of a method according to embodiments of the present technology.

FIGS. 4A and 4B show the detection of light off a target and dimensional data from the detection of light according to embodiments of the present technology.

FIGS. 5A and 5B show structures on the bottom side of a roof and dimensional data of the structures on the bottom side of the roof according to embodiments of the present technology.

FIGS. 6A, 6B, and 6C show views of the top side of the roof, the bottom side of the roof, and the top side of the roof with structures from the bottom side of the roof visible according to embodiments of the present technology.

FIG. 7 shows a path of generating three-dimensional data of a roof according to embodiments of the present technology.

FIG. 8 shows an output indicating solar panel mounting locations according to embodiments of the present technology.

FIG. 9 shows a block flow diagram of a method for identifying a sagging roof according to embodiments of the present technology.

FIGS. 10A, 10B, and 10C show data used to identify a sagging roof according to embodiments of the present technology.

FIG. 11 shows an example computer system according to embodiments of the present technology.

### DETAILED DESCRIPTION

Solar panels, which may include arrays of solar photovoltaic cells, may be mounted on a building using a frame or other similar mounting system. The solar panels should be stable on the roof of a building. For instance, the panels should not move under their own weight on a sloped roof and also should not move under adverse weather conditions, including heavy winds and precipitation. In order to provide stability, the solar panels should be mounted with a fastener through roof decking to a stronger roof component. Solar panel installers may seek to fasten the solar panel to a rafter (i.e., a beam that runs from the top to the bottom of the roof), a beam in the roof truss, or another structure stronger than roof decking. Fasteners may include, for example, nails, bolts, and screws.

Embodiments of the present technology allow for an accurate, precise, and efficient way to identify locations for fasteners used in the mounting of solar panel frames onto building roofs. By capturing data of the top side of the roof, capturing data of the bottom side of the roof, possibly correlating common features, or a combination of two or more of these operations, the location of rafters and other structures normally visible only from the bottom side of the roof may be known with a high degree of certainty when on the top side of the roof Knowing the location of structures on the bottom side of the roof while on the top side of the roof may reduce installation time, reduce installation costs, improve roof longevity, and increase market acceptance of solar panels. Installing solar panels already may require taking images or generating dimensional data of the roof to understand optimal placement of the solar panels, and in some embodiments, these images or dimensional data may be used for locating rafters and other structures.

Conventional methods of installing solar panels may include a technician measuring locations of rafters and other structures while in an attic or unfinished portion of the building under the roof prior to installing the solar panels. Measurements may be time consuming both for the technician and the building owner. The building owner or technician may need to clear out space in order for the technician to have enough room to complete measurements. The technician may also need to take measurements on the top of the roof and then transform the measurements taken on the bottom side of the roof to the coordinate system on the top of the roof. Measurements may also depend on the skill and experience of an individual technician. The measurements and information of rafters and other structures may then be passed on to a second individual, the installer. The transfer of information introduces another layer where errors can be introduced into the process. The installer may misinterpret the technician's measurements, or the technician may not include sufficient documentation for the installer to understand the technician's measurements. The accuracy and precision of determining mounting locations based on the technician's measurements may depend significantly on the skill and experience of an individual installer. Some installers may locate rafters by knocking on the roof and listening for changes in the sound of the knock. This knock method may not be accurate or precise. Stud detectors, which may be used on drywall to determine location of beams in a wall, may not work for roofing applications as a result of the variation of thickness of shingles and rough surface of shingles.

Conventional methods may also include installing a flashing, a metal sheet, over a hole that is formed in the roof to mount a solar panel. These flashing sheets may be made to size large enough to cover not only the correct drill hole but also other drill holes that may have been created by mistake. Embodiments of the present technology may reduce the size of the flashing used in installation, saving on material costs. In some examples, the flashing may be eliminated.

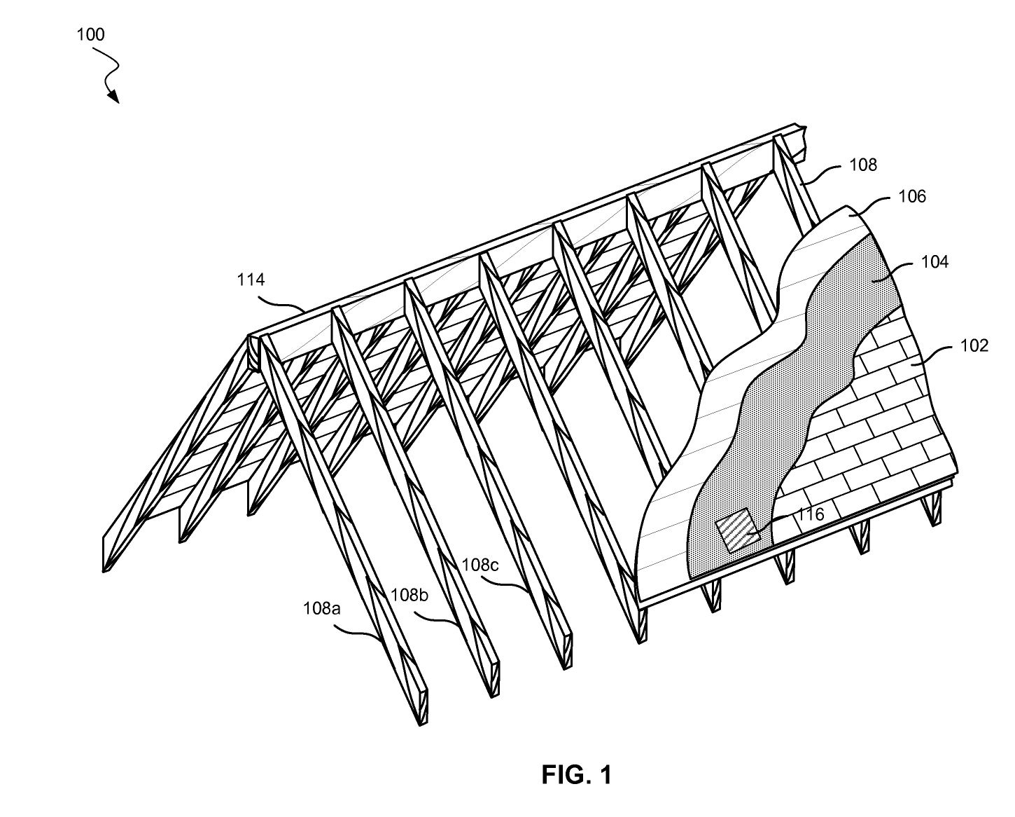

Turning to the figures, FIG. 1 shows a top view of roof 100, with a cutaway to show various components of roof 100 including shingles 102, underlayment 104, decking 106 and rafters 108. Roof 100 is an example of one type of roof that may be the intended location for a solar panel installation and may be a roof on a residential building or a commercial building, such as an office building or an industrial building. Shingles 102, which may be asphalt, metal, tile, or other materials, are visible in a top view of finished roofs. Shingles 102 may be installed on top of underlayment 104, which in turn is installed on top of decking 106. Decking may also be called sheathing. Decking 106 may be plywood, oriented strand board (OSB), or any other suitable material. Underlayment 104 protects decking 106 from moisture and may be, for example, asphalt-saturated building paper, rubberized asphalt, or a synthetic material. In some embodiments, a roof may not have shingles. For example, the roof may be coated with tar, a rubber, or a polymer mat. Similarly, in some embodiments, a roof may not have an underlayment. Embodiments of the present technology may be applicable to any roof known to one of skill in the roofing or solar installation arts.

Each of shingles 102, underlayment 104, and decking 106 are shown as cutaways to provide a view of the plurality of rafters 108 that provide structural support to roof 100 and decking 106. Individual rafters 108a, 108b, and 108c are examples of specific rafters that provide structural support to roof 100. The plurality of rafters may be spaced equally. For example, the distance between rafter 108a and rafter 108b may be the same as between rafter 108b and rafter 108c. However, with some roof, particularly with less traditional roofs, the rafters may not be spaced equally. Rafters on one side of the roof may meet rafters from another side of the roof at a tie beam 114. The line where both sides of roof 100 meet may be termed the ridge. One or more features 116 may be visible on the top side of roof 100. Feature 116 may be a vent, an exhaust, a beacon added to the roof, or another structure attached to roof 100. Feature 116 may not be covered by shingles 102. Although roof 100 is shown in FIG. 1 as sloping, a roof for a solar installation may be flat.

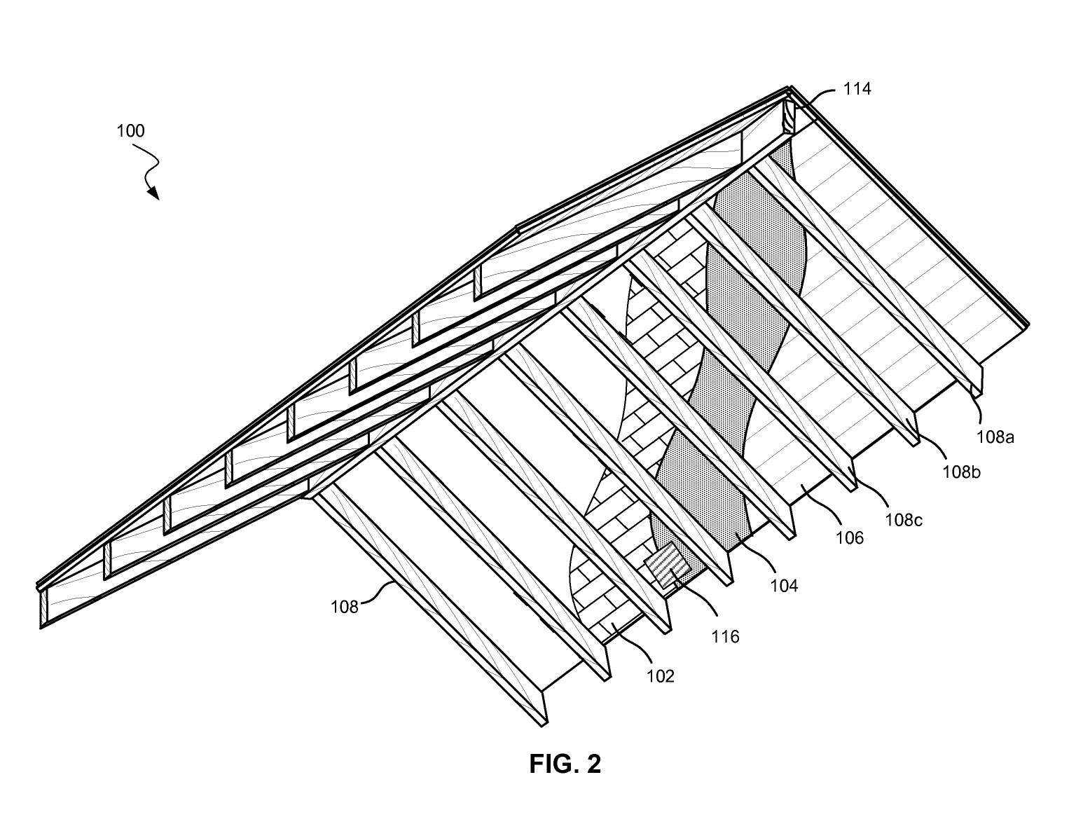

FIG. 2 shows a bottom view of roof 100. Plurality of rafters 108, rafter 108a, rafter 108b, and/or rafter 108c may be visible. Rafters from one side of roof 100 may meet rafters from another side of roof 100 at tie beam 114. Each of shingles 102, underlayment 104, and decking 106 are shown as cutaways. Feature 116 may be visible and may not be covered by decking 102. The view of the bottom of roof 100 may be visible from an attic or an unfinished portion of the building.

Other parts or terms describing the roof may include eaves (i.e., the lower edges of a roof that extend past the building structure); valley (i.e., an angle formed at the intersection of two sloping roof sections); truss (i.e., a support framework of beams that support the roof and may include the rafters); and joist (i.e., with a flat roof, the horizontal structure to which the decking is fastened).

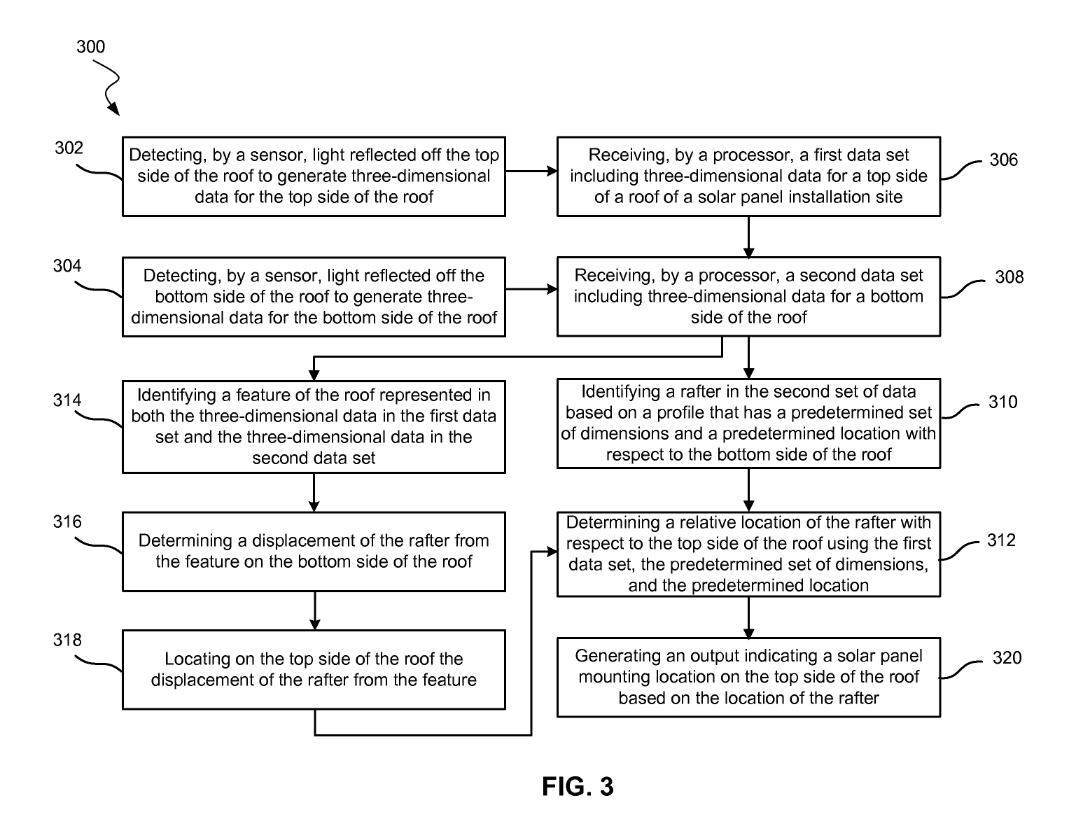

As shown in FIG. 3, embodiments of the present technology may include method 300 to indicate a solar panel mounting location on a roof, such as roof 100. Method 300 may include detecting, by a sensor, light reflected off the top side of the roof to generate three-dimensional (3D) data for the top side of the roof (block 302). Similarly, method 300 may also include detecting, by a sensor, light reflected off the bottom side of the roof to generate three-dimensional data for the bottom side of the roof (block 304).

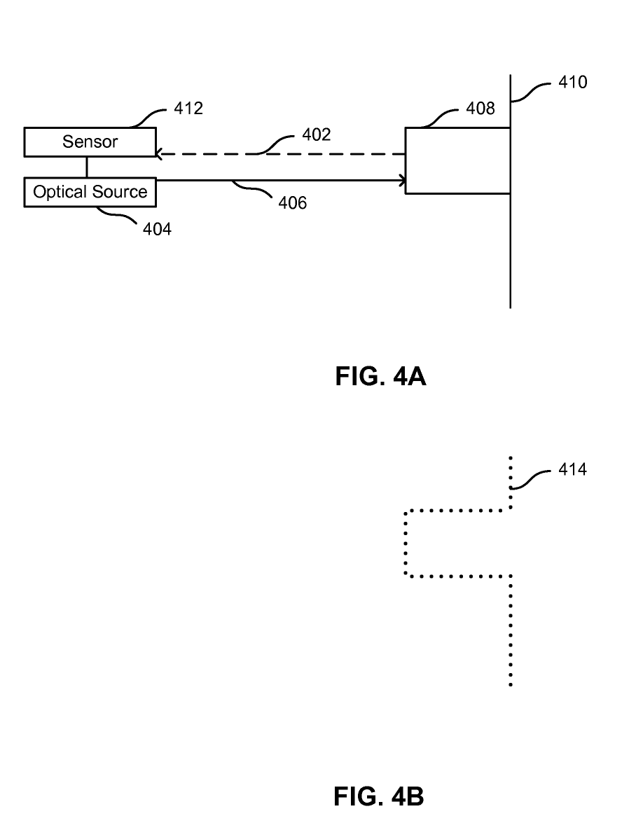

FIGS. 4A and 4B shows an example of how 3D data may be generated. Light reflected off the top side or the bottom side of the roof may follow reflected optical path 402 and may be from an optical source 404. The optical source may be a manufactured device that emits a visible, ultraviolet, and/or infrared wavelength of light. In some embodiments, the optical source may be a light emitting diode. In additional embodiments, the optical source may be a laser, and the light may be a laser beam. The use of a laser may be similar or the same as the use of a laser in lidar sensing technology. Light from optical source 404 then follows optical path 406, and illuminates rafter 408 on decking 410. Light following reflected optical path 402 may then be detected by sensor 412. The difference in timing of light reflected off of rafter 408 and decking 410 may allow for the determination of the different distances of rafter 408 and decking 410. Optical source 404 may be communicatively coupled to sensor 412 in order to determine timing differences. The illumination and detection of light may be at discrete locations and may generate a point cloud 414 of FIG. 4B. FIG. 4B shows a 2D point cloud for clarity of the illustration, but a 3D point cloud may be generated by these and similar techniques.

In some embodiments, method 300 may exclude an optical source coupled to a sensor. Light that reflects off of the top side or the bottom side of the roof may be from a natural source, such as the sun or an artificial source that is not coupled to a sensor. The artificial source may be room lighting, a camera flash, an LED lamp, or other similar sources, and the artificial source may have its primary function to better illuminate shaded areas. The sensor may be a charged coupled device (CCD) or any sensor that can detect photons or electromagnetic radiation. In embodiments, the sensor may be part of a camera, including a light-field camera. In some embodiments, the sensor may be a depth sensor, and the depth sensor may be mounted on a device, such as a digital camera, that captures additional image information. The digital camera may have a camera lens in addition to the depth sensor. In embodiments without a sensor coupled to an optical source, a 3D point cloud may still be generated from an image captured by the sensor.

The 3D data of the top side of the roof may include detections at different times, such as image or video taken by a technician or installer on the roof or from a nearby vantage point that provides a view of the roof, image or video data taken with a sensor mounted on a drone or other airborne vehicle, satellite images, or the like. Similarly, the 3D data for the bottom side of the roof may include image or video data taken by a technician or installer under the roof, and may be taken with a sensor mounted on a drone or other airborne vehicle.

Method 300 may include receiving, by a processor, a first data set including three-dimensional data for a top side of a roof of a solar panel installation site (block 306), as shown in FIG. 3. Method 300 may also include receiving, by a processor, a second data set including three-dimensional data for a bottom side of the roof (block 308). In some examples, the 3D data may be sent from a camera or a lidar system to a computing system. The processor and the camera or lidar system may or may not be part of the same physical device. The three-dimensional data for the top side of the roof and/or the bottom side of the roof may be a point cloud. A point cloud may be a set of data points in a coordinate system, which may include a 3D coordinate system, where the data points are intended to represent the external surface of the represented object. In embodiments, point clouds may be converted to a polygon or triangle mesh.

Method 300 may further include identifying a rafter in the second data set based on a profile (block 310). The profile may have a predetermined set of dimensions and a predetermined location with respect to the bottom side of the roof The predetermined set of dimensions and/or the predetermined location may be based on a standard in roof construction or other trade standard. Standards may be based on builder, subdivision, or geographic location. For example, a rafter may be required to have dimensions (in inches), such as 2×4, 2×6, 2×8, or 2×10. These dimensions may differ by rafter material, geographic location, roof type, and building use. Rafters may be made of wood, steel, aluminum, composites, metals, metal alloys, or other appropriate materials. In some cases, identifying the dimensions or configuration of the rafter may help identify the material. The type of rafter material may inform installation decisions and deflection judgments.

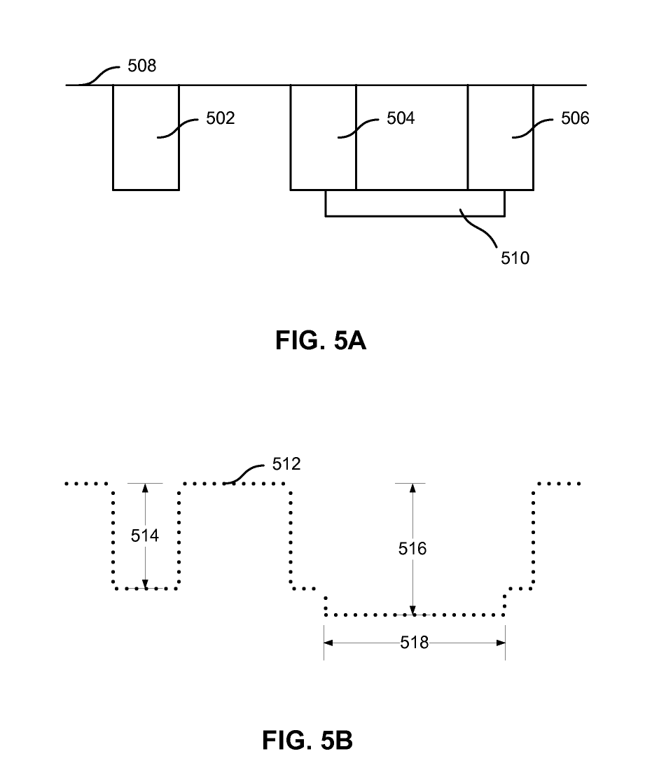

Rafters may also have certain predetermined locations with respect to the bottom side of the roof The predetermined location may include the proximity of a rafter to decking. For example, FIG. 5A shows how rafter 502, rafter 504, and rafter 506 are flush with decking 508. FIG. 5A also shows a possible configuration where structure 510 may be attached to rafter 504 and rafter 506. Structure 510 may be a wood board or a decorative feature (e.g., a picture frame) attached to the rafters. FIG. 5B shows point cloud 512 generated from the configuration of FIG. 5A. Because the predetermined location of a rafter may include that the rafter is directly adjacent or abuts decking, structure 510 may not be identified as a rafter. If the spacing between structure 510 and decking 508 is not visible in a point cloud, identification of a rafter may also include using the predetermined set of dimensions. Distance 514 of rafter 502 would be limited to a possible dimension of the rafter, such as 4 in, 6 in, 8 in, or 10 in. If distance 516 is not one of those dimensions, then structure 510 may not be identified as a rafter. Furthermore, width 518 of structure 510 may not be in the predetermined set of dimensions. Additionally, once other rafters, such as rafter 514, are identified, the appropriate dimension of the predetermined set of dimensions may be known with more certainty, and identification of structure 510 as not a rafter may be known with more confidence. The predetermined location of a rafter with respect to the bottom side of the roof may also include the location of a rafter at certain locations in a roof. For example, a rafter may be located at or near the edge of the roof The next rafter may be 12 inches, 18 inches, 24 inches, 30 inches, or 36 inches away from the first rafter according to embodiments. The dimensions of the rafter, the distance of a rafter from the decking, the spacing between adjacent rafters, or any combination of these can be part of the profile.

The rafter may be identified based on the combination of the predetermined set of dimensions and the predetermined location. In some examples, the rafter may be identified based on either the predetermined set of dimensions or the predetermined location but not both. In some embodiments, a rafter may be identified through image recognition techniques, including identifying color variations, shadows, and edges of objects.

Additionally, with returning reference to FIG. 3, method 300 may include determining a relative location of the rafter with respect to the top side of the roof (block 312). Determining the relative location may include identifying a feature of the roof represented in both the three-dimensional data in the first data set and the three-dimensional data in the second data set (block 314). In other words, the relative location may include using a feature of the roof common to both the top side of the roof and the bottom side of the roof For example, a common feature may include a roof ridge, an edge of the roof, a valley, a rake, an eave, an exhaust, a chimney, or a vent. The common feature may be a beacon added for the purpose of providing a common point to both the top side of the roof and the bottom side of the roof As used herein, a “beacon” can be any device that is installed on or attached to the roof such that its position can be readily identified in the 3D data from the top of the roof and the 3D data for the bottom of the roof. The beacon may be inserted through the roof In some instances, a beacon may be added to both sides of the roof, using magnets that should be in the same position on the top side of the roof and on the bottom side of the roof The beacon may be a passive beacon, which has as its main function creating a common location visible on both sides of the roof For example, the beacon may be a highly reflective marker or include a QR code (or other machine-readable code) and provide orientation information to be used in conjunction with the images or lidar data used to create the 3D data set. In addition, the beacon may actively send out an electromagnetic signal, allowing a processor to determine the location of the beacon even if the beacon may not be captured in the three-dimensional data. The beacon may include accelerometer, GPS, or other positional data. The beacon may be placed in predetermined locations in order to aid in identifying location of rafters in the 3D data. A plurality of beacons may be used in embodiments.

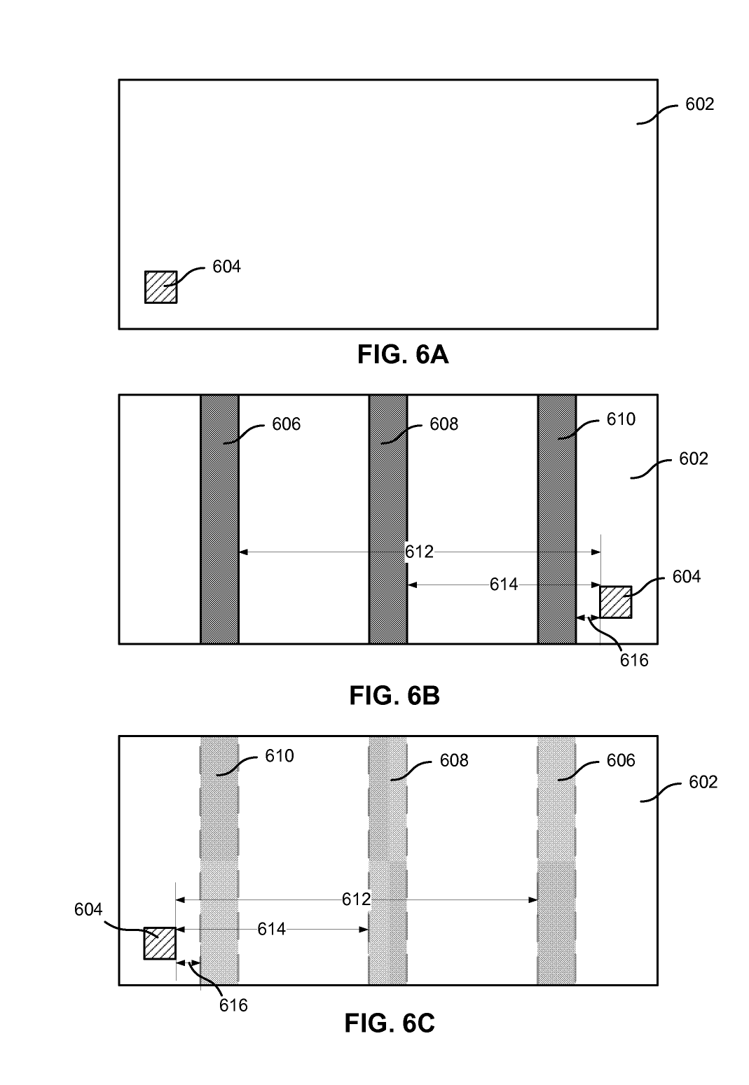

Determining the relative location of the rafter may include determining a displacement of the rafter from the feature on the bottom side of the roof (block 316). Method 300 may then include locating on the top side of the roof the displacement of the rafter from the feature (block 318). For instance, from the three-dimensional data of the bottom side of the roof, a rafter may be determined to be a given displacement from an edge of the roof The given displacement can then be used to locate the rafter by marking off the given displacement from the edge of the roof on the top side of the roof FIGS. 6A, 6B, and 6C show elements of determining the relative location of the rafter. FIG. 6A shows a simplified view of the top side of the roof 602 with feature 604. FIG. 6B shows a simplified view of the bottom side of roof 602. In FIG. 6B, a portion of feature 604 is visible. Rafter 606, rafter 608, and rafter 610 are visible on the bottom side of roof 602. Displacement 612, displacement 614, and displacement 616 of the rafters from feature 604 may be determined. As a result, the relative location the rafter with respect to the top side of the roof may be known. FIG. 6C shows the relative location of rafter 606, rafter 608, and rafter 610 with respect to the top side of the roof.

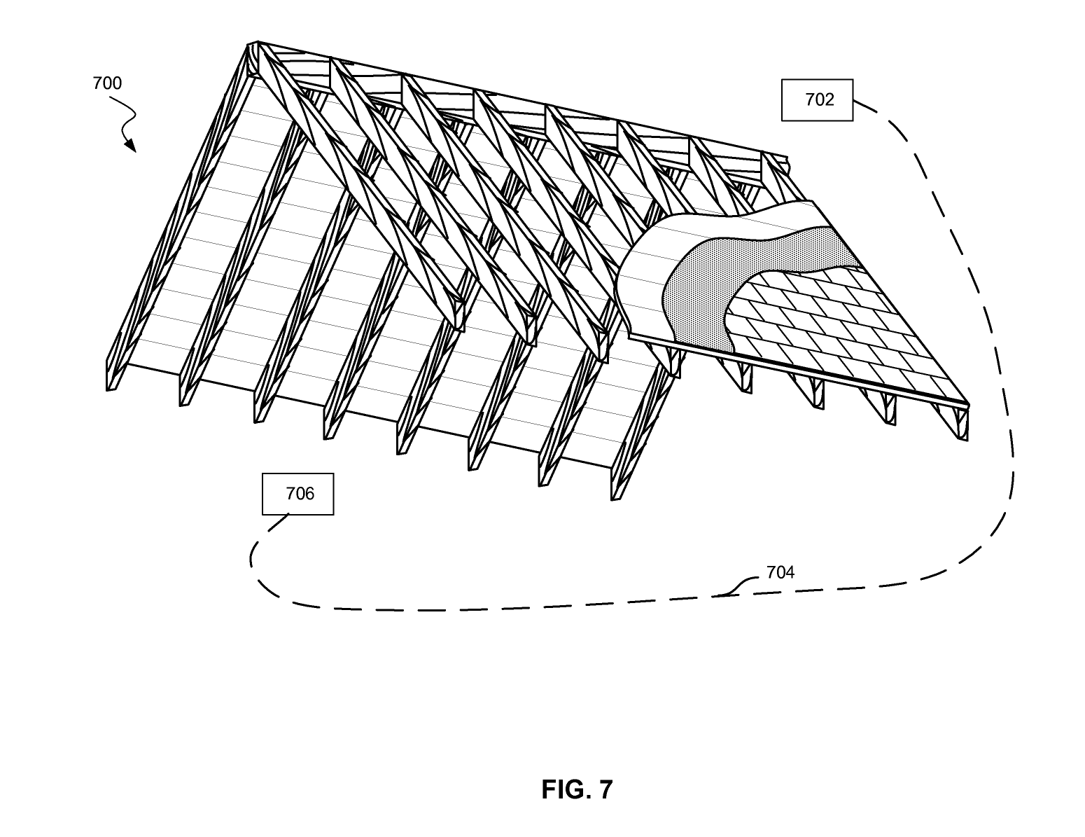

Determining the relative location of the rafter with respect to the top side of the roof may exclude the use of a feature common to both the top side of the roof and the bottom side of the roof The method may include accelerometer, location, and/or GPS data between and/or during the photographs. As shown in FIG. 7, image data may be generated at position 702. The location of the sensor during the image generation may be known. The sensor may move along path 704 from the top side of the roof to the bottom side of the roof Path 704 may include moving from outside the building to inside the building. During the movement of the sensor from the top side of the roof to the bottom side of the roof, the location and/or speed of the sensor may be captured by an accelerometer, GPS, and/or other similar system. Location data may be aided by a beacon or a locator installed in the building, on the roof, or on the premises surrounding the building. When image data from the bottom side of the roof is generated at position 706, an accurate and precise location of the image generation may be known relative to the top side of the roof This process may be a dead reckoning process. The order of generating data from the top side of the roof and the bottom side of the roof may be switched. Additionally, generating data may alternate between the top side of the roof and the bottom side of the roof. Generating data is not limited to capturing a still image (which may be a photograph or lidar data) and may include video recording.

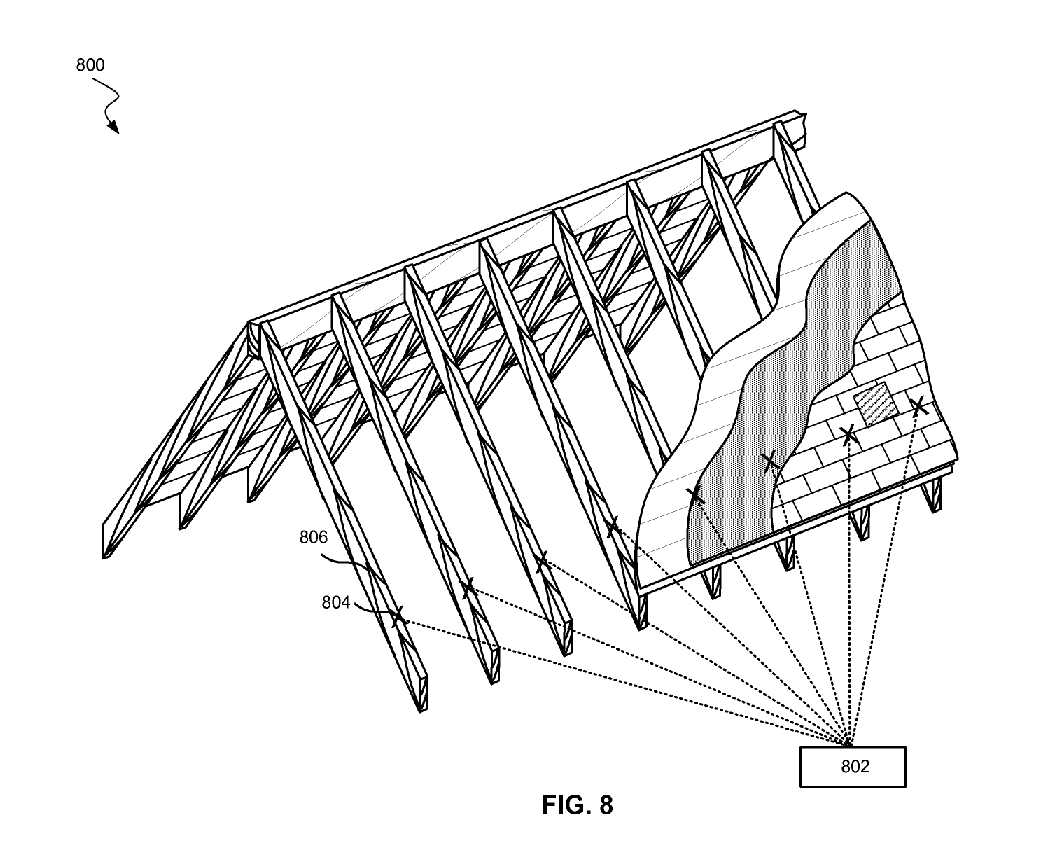

Once the relative location of the rafter with respect to the top side of the roof is determined, an output indicating a solar panel mounting location on the top side of the roof based on the location of the rafter may be generated (block 320). The output may be generated using a variety of different techniques. In some embodiments, the output is projected by a laser onto the top side of the roof For example, as shown in FIG. 8, the output may be a laser guide indicating the location of the rafter or where the solar panel should be mounted. Laser 802 may mark location 804, which would indicate where a fastener should be attached to rafter 806. The output may be printed onto a physical template, with guides for where fasteners should be inserted into the roof and through a rafter. In some embodiments, the output may be viewed on a video screen. For example, the location of the rafter or where fasteners should be installed may be displayed on a smartphone, tablet, smartwatch, computer monitor, or laptop. These screens may provide an augmented reality view of structures visible on the bottom side of the roof The output may include a representation of the bottom side of the roof, the location of the rafter, and/or where fasteners should be installed. An output may be similar to FIG. 6C. The representation may be overlaid on a photographic or real-time image of the roof

Embodiments may include using two-dimensional data instead of three-dimensional data. For example, the location of rafter 606, rafter 608, and rafter 610 in FIG. 6B may be determined by image recognition techniques from a two-dimensional image of the bottom side of the roof generated by a camera. The relative location of rafter 606, rafter 608, and rafter 610 with respect to feature 604 may be known. The location of rafter 606, rafter 608, and rafter 610 relative to the top side of the roof may be determined using the location of feature 604 in a two-dimensional image of the top side of the roof. An output, similar to FIG. 6C, showing the location of rafter 606, rafter 608, and rafter 610 as viewed from the top side of the roof may be generated.

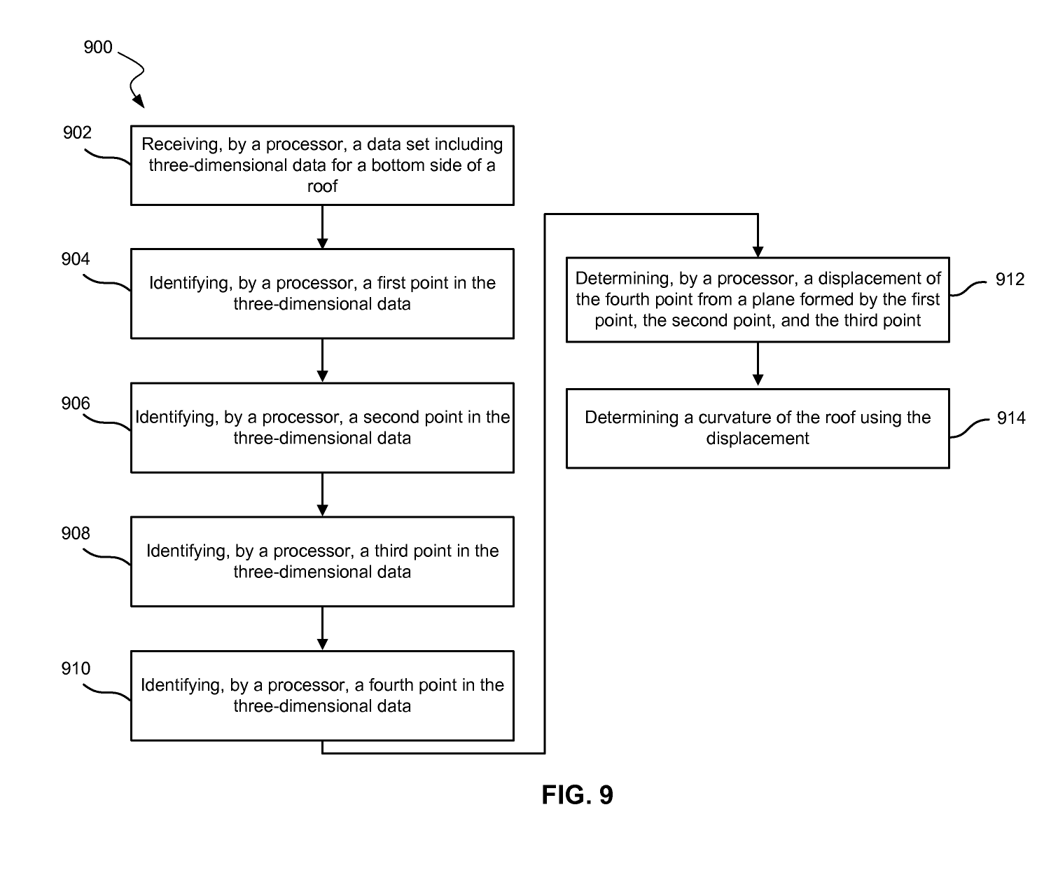

As shown in FIG. 9, some embodiments may include method 900 to determine the deflection of a roof. Method 900 may include receiving, by a processor, a data set including three-dimensional data for a bottom side of a roof of a solar panel installation site (block 902). Method 900 may also include identifying four points in the three-dimensional data: identifying a first point (block 904), a second point (block 906), a third point (block 908), and a fourth point (block 910). Each of these points in the three-dimensional data may be the center of a region of a plurality of points. The region may have a predetermined size. The predetermined size may be a circle having a diameter. The diameter may be greater than the width of a rafter. In some examples, the diameter may be 105%, 110%, 120%, 130%, 140%, 150%, or 200% greater than the width of the rafter. Within each region, the difference in depth between any two points of the plurality of points may be less than a predetermined depth. The predetermined depth may be equal to or less than the height of a rafter. In some examples, the predetermined depth may be 100%, 90%, 80%, 70%, 60%, 50%, 40%, 30%, 20%, or 10% of the height of the rafter. Method 900 may further include determining a displacement of one of the four points from a plane formed by the other three points (block 912). In addition, method 900 may include determining a deflection of the roof using the displacement (block 914). In some examples, a method may include determining a deflection of a rafter in addition to or instead of the roof

The deflection of the roof, rafter, or other structure may be important in determining if the roof can support a solar panel installation. In some cases, deflection is measured as a fraction of the span. The span may be the distance between load bearing supports. A load bearing support may be a truss or a wall. Deflection may be measured from roof peak to the gutter or from edge-to-edge (e.g., truss to truss). A roof that sags with a deflection greater than that allowed by building codes or by solar installation codes may be disqualified from a solar panel installation. In some embodiments, a roof that sags with a deflection of greater than or equal to 1/800 may be disqualified. For example, a roof may be disqualified if the deflection is greater than or equal to 1/600, 1/400, or 1/200. In the case of a sagging roof, the roof should be replaced before solar panels are installed. The sagging of the roof typically is identified through unassisted human observation.

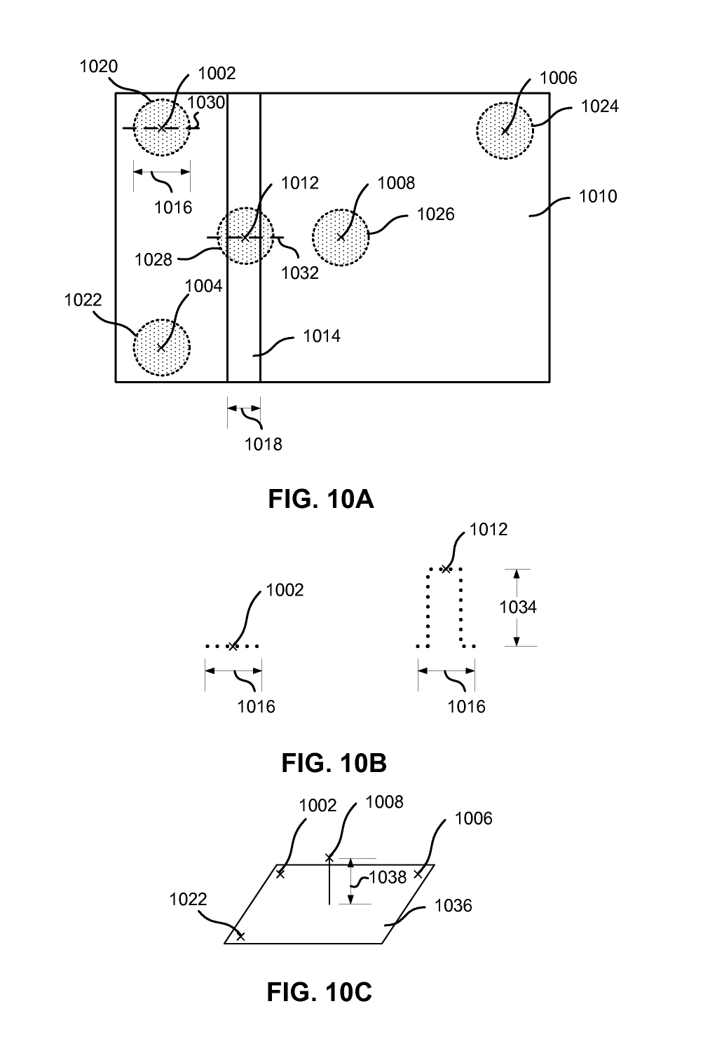

FIGS. 10A, 10B, and 10C show an example of possible points used in a method similar to method 900. Point 1002, point 1004, point 1006, and point 1008, all of which sit on the decking 1010 may be points identified by method 900, while point 1012, which sits on rafter 1014 is not one of the four points identified by method 900. In FIG. 10A, the predetermined size is a circle having diameter 1016, which is greater than width 1018 of rafter 1014. As a result, point 1002, point 1004, point 1006, and point 1008 are centers of region 1020, region 1022, region 1024, and region 1026, respectively. Point 1012 is the center of region 1028. The dimensional data for point 1002 along cross section 1030 and point 1012 along cross section 1032 may appear as in FIG. 10B. FIG. 10B shows dimensional data in two dimensions, but dimensional data may be in three dimensions in embodiments.

Because region 1020 and region 1028 are circles with diameter 1016 and if the decking is flat, the dimensional data for region 1020 may appear flat. In contrast, the dimensional data for region 1028 may not be flat and show the profile of rafter 1014 because region 1028 has diameter 1016 greater the width of rafter 1014. The dimensional data for region 1028 would show height 1034 of the rafter. Because method 900 and similar methods may not want to use a point on a rafter measured against points on decking to determine the deflection of a roof, method 900 may require that the difference in depth between any two points in a region may have to be less than the height of a rafter. Because at least two points in region 1028 have a difference in depth equal to the height of rafter 1014, point 1012 cannot be identified as a point in method 900. Point 1002, point 1004, point 1006, and point 1008 may be identified as the four points. Three of these points—point 1002, point 1004, point 1006—define plane 1036. Displacement 1038 of point 1008 from plane 1036 can be determined. The deflection of the roof at point 1008 can then be determined. Planes defined by any three of point 1002, point 1004, point 1006, and point 1008 can be used to determine the displacement of the remaining point. The three points 1002, 1004, and 1006, each may be near a different corner of the roof The distance between any two of point 1002, point 1004, and point 1006 may be at least a predetermined distance. For example, the predetermined distance may be greater than 40%, 50%, 60%, 70%, 80%, or 90% of the width of the roof Point 1008 may be at or near the center of the roof. For example, point 1008 may be in the center 10%, 20%, 30%, 40%, or 50% of the roof by area. This method may be repeated for additional points identified to meet the criteria discussed above, and the defections obtained may be averaged across the different planes generated by additional points.

Embodiments of the present technology may include a computer system. The computer system may include a non-transitory computer readable medium storing a plurality of instructions that when executed control a computer system to generate an output indicating a solar panel mounting location on the top side of a roof of a solar panel installation site. The instructions may include receiving a first data set including three-dimensional data for a top side of a roof of a solar panel installation site. The instructions may also include receiving a second data set including three-dimensional data for a bottom side of the roof. Additionally, the instructions may include identifying a rafter in the second data set based on a profile. The profile may include a predetermined set of dimensions and a predetermined location with respect to the top side of the roof Furthermore, the instructions may include determining a relative location of the rafter with respect to the top side of the roof using the first data set, the predetermined set of dimensions, and the predetermined location. The instructions may include any operations in methods described herein.

Embodiments of the present technology may include a method to generate an output indicating a solar panel mounting location. In some embodiments, methods may be extended to other rooftop applications, not limited to mounting solar panels. The method may include receiving, by a processor, a first data set including three-dimensional data for a top side of a roof of the solar panel installation site. The method may also include, receiving, by a processor, a second data set including three-dimensional data for a bottom side of the roof The method may include any three-dimensional data or operations to obtain three-dimensional data described herein.

The method may further include identifying a structure in the second data set based on a profile. The structure may be a joist, a rafter, a truss, or other beam of the roof In some embodiments, the structure may be any appropriate supporting structure within the roof. The profile may have a predetermined set of dimensions and a predetermined location with respect to the bottom side of the roof In addition, the method may include determining a relative location of the structure with respect to the top side of the roof using the first data set, the predetermined set of dimensions, and the predetermined location. The method may also include generating an output indicating a solar panel mounting location on the top side of the roof based on the location of the structure. The structure may be the target for a fastener attached to a solar panel mounting frame. Methods described herein that applied to a rafter may also be applied more generally to a structure, including a joist or a truss. In some embodiments, methods may be used to determine the location of an underlying structure, even if the location of the underlying structure may not be used for a solar panel installation.

Embodiments of the present technology may also identify structures that cannot be used for solar panel installation. For example, a solar panel may not be mounted onto the eaves of a roof. Outputs generated by methods may also indicate what locations are not suited for mounting solar panels. Methods described herein may not be limited to mounting solar panels and may include any structure that may be mounted onto a roof These structures may include, for example, a satellite dish, an evaporative cooling system, and a water handling system.

### Example System Architecture

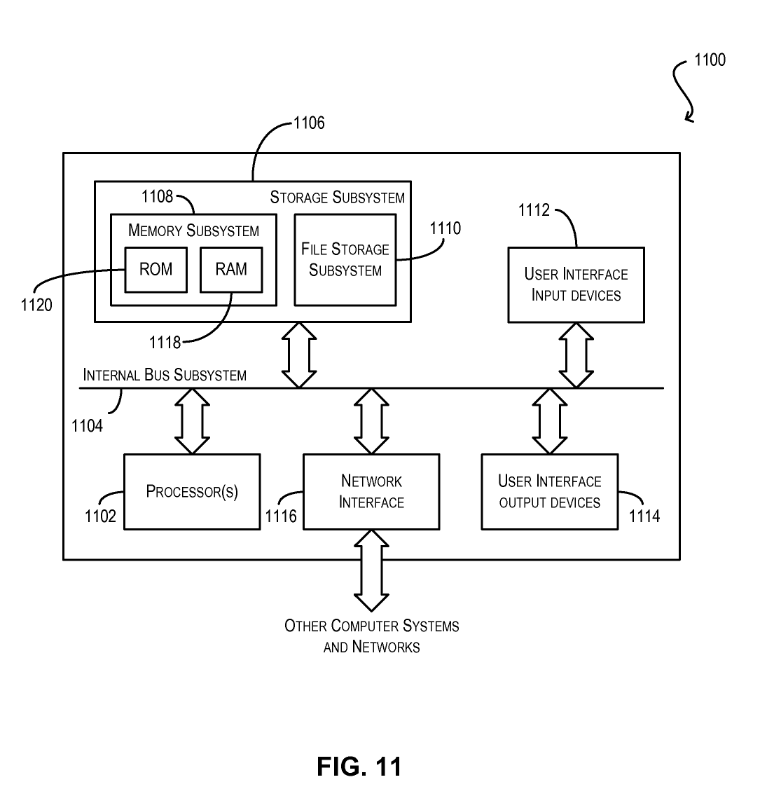

FIG. 11 is a simplified block diagram of a computer system 1100 according to an embodiment of the present invention. Computer system 1100 can be used to implement any of the computer systems/devices described herein. As shown in FIG. 11, computer system 1100 can include one or more processors 1102 that communicate with a number of peripheral devices via a bus subsystem 1104. These peripheral devices can include a storage subsystem 1106 (comprising a memory subsystem 1108 and a file storage subsystem 1110), user interface input devices 1112, user interface output devices 1114, and a network interface subsystem 1116.

Internal bus subsystem 1104 can provide a mechanism for letting the various components and subsystems of computer system 1100 communicate with each other as intended. Although internal bus subsystem 1104 is shown schematically as a single bus, alternative embodiments of the bus subsystem can utilize multiple buses.

Network interface subsystem 1116 can serve as an interface for communicating data between computer system 1100 and other computer systems or networks. Embodiments of network interface subsystem 1116 can include wired interfaces (e.g., Ethernet, CAN, RS232, RS485, etc.) or wireless interfaces (e.g., ZigBee, Wi-Fi, cellular, etc.).

User interface input devices 1112 can include a keyboard, pointing devices (e.g., mouse, trackball, touchpad, etc.), a scanner, a barcode scanner, a touch-screen incorporated into a display, audio input devices (e.g., voice recognition systems, microphones, etc.), and other types of input devices. In general, use of the term “input device” is intended to include all possible types of devices and mechanisms for inputting information into computer system 1100.

User interface output devices 1114 can include a display subsystem, a printer, a fax machine, or non-visual displays such as audio output devices, etc. The display subsystem can be a cathode ray tube (CRT), a flat-panel device such as a liquid crystal display (LCD) or light emitting diode (LED), or a projection device. In general, use of the term “output device” is intended to include all possible types of devices and mechanisms for outputting information from computer system 1100.

Storage subsystem 1106 can include a memory subsystem 1108 and a file/disk storage subsystem 1110. Subsystems 1108 and 1110 represent non-transitory computer-readable storage media that can store program code and/or data that provide the functionality of embodiments of the present invention.

Memory subsystem 1108 can include a number of memories including a main random access memory (RAM) 1118 for storage of instructions and data during program execution and a read-only memory (ROM) 1120 in which fixed instructions are stored. File storage subsystem 1110 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art. Processor 1102 may be a processor used to receive and process data in the methods described herein.

Computer system 1100 is illustrative and not intended to limit embodiments of the present technology. Many other configurations having more or fewer components than system 1100 are possible.

In the preceding description, for the purposes of explanation, numerous details have been set forth in order to provide an understanding of various embodiments of the present technology. It will be apparent to one skilled in the art, however, that certain embodiments may be practiced without some of these details, or with additional details.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Additionally, details of any specific embodiment may not always be present in variations of that embodiment or may be added to other embodiments.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither, or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a method” includes a plurality of such methods and reference to “the rafter” includes reference to one or more rafters and equivalents thereof known to those skilled in the art, and so forth. The invention has now been described in detail for the purposes of clarity and understanding. However, it will be appreciated that certain changes and modifications may be practice within the scope of the appended claims.

What is claimed is:

1. A method comprising:
receiving, by a processor, a first data set including three-dimensional data for a top side of a roof of a solar panel installation site;
receiving, by a processor, a second data set including three-dimensional data for a bottom side of the roof;
identifying a rafter in the second data set based on a profile that has:
a predetermined set of dimensions, and
a predetermined location with respect to the bottom side of the roof;
determining a relative location of the rafter with respect to the top side of the roof using the first data set, the predetermined set of dimensions, and the predetermined location; and
generating an output indicating a solar panel mounting location on the top side of the roof based on the relative location of the rafter.

2. The method of claim 1, wherein the three-dimensional data for the top side of the roof is a point cloud.

3. The method of claim 1, wherein the three-dimensional data for the bottom side of the roof is a point cloud.

4. The method of claim 1, wherein the output is projected by a laser onto the top side of the roof.

5. The method of claim 1, further comprising:
generating the three-dimensional data for the top side of the roof comprises detecting light reflected off the top side of the roof

6. The method of claim 5, wherein the light is a laser beam.

7. The method of claim 5, wherein detecting light reflected off the top side of the roof is by a sensor mounted on a vehicle controlled remotely by a user.

8. The method of claim 1, further comprising:
generating the three-dimensional data for the bottom side of the roof comprises detecting light reflected off the bottom side of the roof

9. The method of claim 8, wherein detecting the bottom side of the roof is by an optical source mounted on a vehicle controlled remotely by a user.

10. The method of claim 1, wherein the predetermined set of dimensions and the predetermined location are based on a standard or standards in roof construction.

11. The method of claim 1, wherein determining the relative location of the rafter with respect to the top side of the roof comprises:
identifying a feature of the roof represented in both the three-dimensional data in the first data set and the three-dimensional data in the second data set.

12. The method of claim 11, wherein determining the relative location of the rafter with respect to the top side of the roof further comprises:
determining a displacement of the rafter from the feature on the bottom side of the roof.

13. The method of claim 12, wherein the feature is a beacon, an exhaust, a roof ridge, or an edge of the roof

14. The method of claim 12, wherein determining the relative location of the rafter with respect to the top side of the roof further comprises:
locating on the top side of the roof the displacement of the rafter from the feature.

15. The method of claim 1, further comprising:
detecting, by a sensor, light reflected off the top side of the roof to generate the three-dimensional data for the top side of the roof;
detecting, by the sensor, light reflected off the bottom side of the roof to generate the three-dimensional data for the bottom side of the roof; and
receiving, by a processor, a third data set including accelerometer data of the sensor between detecting light reflected off the top side of the roof and detecting light reflected off the bottom side of the roof;
wherein determining the relative location of the rafter with respect to the top side of the roof further comprises using the accelerometer data.

16. The method of claim 1, further comprising:
placing a beacon on the roof, wherein the beacon is detectable by a sensor detecting light reflected off the top side of the roof, and the beacon is detectable by the sensor detecting light reflected off the bottom side of the roof

17. A method comprising:
receiving, by a processor, a data set including three-dimensional data for a bottom side of a roof;
identifying, by a processor, a first point in the three-dimensional data;
identifying, by a processor, a second point in the three-dimensional data;
identifying, by a processor, a third point in the three-dimensional data;
identifying, by a processor, a fourth point in the three-dimensional data;
determining, by a processor, a displacement of the fourth point from a plane formed by the first point, the second point, and the third point; and
determining a deflection of the roof using the displacement, wherein:
the first point is a center of a first region of a first plurality of points, the first region having a predetermined size,
the difference in depth between any two points of the first plurality of points is less than a predetermined depth,
the second point is a center of a second region of a second plurality of points, the second region having the predetermined size,
the difference in depth between any two points of the second plurality of points is less than the predetermined depth,
the third point is a center of a third region of a third plurality of points, the third region having the predetermined size,
the difference in depth between any two points of the third plurality of points is less than the predetermined depth,
the fourth point is a center of a fourth region of a fourth plurality of points, the fourth region having the predetermined size,
the difference in depth between any two points of the fourth plurality of points is less than the predetermined depth.

18. The method of claim 17, wherein the predetermined size is a circle having a diameter greater than the width of a rafter on the roof

19. The method of claim 17, further comprising flagging the roof as unsuitable for a solar panel installation site if the deflection of the roof is greater than 1/600.

20. A computer system comprising:
a non-transitory computer readable medium storing a plurality of instructions that when executed control the computer system to generate an output indicating a solar panel mounting location on the top side of a roof of a solar panel installation site, the plurality of instructions comprising:
receiving a first data set including three-dimensional data for a top side of a roof of the solar panel installation site;
receiving a second data set including three-dimensional data for a bottom side of the roof;
identifying a rafter in the second data set based on a profile that has:
a predetermined set of dimensions, and
a predetermined location with respect to the bottom side of the roof; and
determining a relative location of the rafter with respect to the top side of the roof using the first data set, the predetermined set of dimensions, and the predetermined location.
